(19) United States
(12) Patent Application Publication
(10) Pub. No.: US 2013/0132907 A1
(43) Pub. Date: May 23, 2013

(54) SHAPE PIXEL RENDERING

(71) Applicants: Timothy W. Kukulski, Oakland, CA (US); Remon Tijssen, Mill Valley, CA (US)

(72) Inventors: Timothy W. Kukulski, Oakland, CA (US); Remon Tijssen, Mill Valley, CA (US)

(73) Assignee: ADOBE SYSTEMS INCORPORATED, SAN JOSE, CA (US)

(21) Appl. No.: 13/039,023

(22) Filed: Mar. 2, 2011

(51) Int. Cl. G06F 3/048

(52) U.S. Cl. 715/838

(57) ABSTRACT

A list of coordinate locations of an icon is determined. Further, each of the coordinate locations is tagged with scaling data to generate a plurality of tagged coordinate locations for the icon. The scaling data indicates an automatic scaling adjustment based on a size of the icon being changed to accommodate a resolution of a display. In addition, the icon is automatically scaled based on the plurality of tagged coordinate locations for the icon and the resolution of the display to generate a scaled icon. The scaled icon is rendered in the display.

### BACKGROUND

1. Field

This disclosure generally relates to display screens. More particularly, the disclosure relates to pixel rendering for display screens.

2. General Background

Screen resolution of computing devices such as smart phones, tablets, PCs, etc. is currently increasing rapidly. Newer computing devices may have as much as twice the resolution of the previous version. With such fast paced changes in resolution, a vast disparity in resolution is found in various devices. With varying screen resolutions and screen sizes, the pixel size is unpredictable. For example, on a high resolution screen with a small pixel size, the small icons and buttons will likely be difficult to utilize. The difficulty is particularly problematic for touch enabled devices. In other words, the icons have not been scaled well to reflect the change in resolution for a given device.

A current approach is to utilized vector-based icons. Vector graphics are utilized as mathematical outlines, i.e., an abstract description of the lines that create the image. The vector graphics are resolution independent. However, vector-based icons typically do not scale well below a certain size. Since many computing devices such as smart phones typically have small icons, the vector graphics approach may not scale well for the icons utilized in those smart phones.

### SUMMARY

In one aspect of the disclosure, a computer program product is provided. The computer program product includes a computer useable medium having a computer readable program. The computer readable program when executed on a computer causes the computer to determine a list of coordinate locations of an icon. Further, the computer readable program when executed on the computer causes the computer to tag each of the coordinate locations with scaling data to generate a plurality of tagged coordinate locations for the icon. The scaling data indicates an automatic scaling adjustment based on a size of the icon being changed to accommodate a resolution of a display. In addition, the computer readable program when executed on the computer causes the computer to automatically scale the icon based on the plurality of tagged coordinate locations for the icon and the resolution of the display to generate a scaled icon. The computer readable program when executed on the computer also causes the computer to render the scaled icon in the display.

In another aspect of the disclosure, a process is provided. The process determines a list of coordinate locations of an icon. Further, the process tags each of the coordinate locations with scaling data to generate a plurality of tagged coordinate locations for the icon. The scaling data indicates an automatic scaling adjustment based on a size of the icon being changed to accommodate a resolution of a display. In addition, the process automatically scales the icon based on the plurality of tagged coordinate locations for the icon and the resolution of the display to generate a scaled icon. The process also renders the scaled icon in the display.

In yet another aspect of the disclosure, a system is provided. The system includes a processor that determines a list of coordinate locations of an icon, tags each of the coordinate locations with scaling data to generate a plurality of tagged coordinate locations for the icon, and automatically scales the icon based on the plurality of tagged coordinate locations for the icon and the resolution of the display to generated a scaled icon. The scaling data indicates an automatic scaling adjustment based on a size of the icon being changed to accommodate a resolution of a display. The system also includes a rendering component that renders the scaled icon in the display.

### DRAWINGS

The above-mentioned features of the present disclosure will become more apparent with reference to the following description taken in conjunction with the accompanying drawings wherein like reference numerals denote like elements and in which:

FIG. 1 illustrates a computing environment that may be utilized for shape scaling in a graphical user interface (“GUI”).

FIG. 2A illustrates an example of an icon that is displayed on a grid.

FIG. 2B illustrates an example of a selection of a vector point.

FIG. 2C illustrates a repositioning of the selected vector point in FIG. 2B.

Further, FIG. 2D illustrates a repositioning of the additional highlighted points illustrated in FIGS. 2B and 2C.

In addition, FIG. 2E illustrates a repositioning of other parts of the icon.

FIG. 2F illustrates the center points of the icon 200 being repositioned.

FIG. 2G illustrates an arrow symbol.

FIG. 3 illustrates a process that provides shape scaling.

FIG. 4A illustrates an example of an image of a magnifying glass having an outline and a lens that have to stay together.

FIG. 4B illustrates a selection of the lens.

FIG. 4C illustrates a plurality of vector points on the outline.

FIG. 4D illustrates a resulting magnifying glass image that has a scaled outline and a scaled lens that conform with one another.

FIG. 5 illustrates a system configuration that may be utilized for navigation. In one embodiment, a scaling module interacts with a memory.

### DETAILED DESCRIPTION

A shape pixel rendering method, system, and computer program product are provided to scale a shape. An example of a shape is an icon, but many other types of shapes may be utilized with the configurations provided for herein. A list of coordinate locations of an icon may be determined. Each of those coordinate locations may be tagged with scaling data that indicates an automatic scaling adjustment based on a size of the icon being changed to accommodate a resolution of a display. The technology that performs the adjustments may be referred to as hinting technology.

With respect to a monochrome icon, shading may be added to the monochrome icon. The shading may follow different rules as the monochrome icon is scaled down. During a scaling down, the rules ensure that the lines remain crisp. For example, one dark pixel instead of two dark pixels may be utilized to indicate an alignment with one or more boundaries.

An outline is a list of coordinate locations that may be utilized, for example, to define an icon. Information is added to individual points in a vector authoring tool to design icons in various sizes. The vector authoring tool may be able to open multiple windows or multiple views that would show how the icon looks in various different sizes. In one embodiment, an automated system identifies when a particular outline does not have enough annotation.

Further, in one embodiment, the shapes are made of outlines with control points. In addition, hinting may be a set of adjustments to those control points. The hinting may be applied as specific pixel densities or output sizes.

The icons utilized with hinting may rotate. Further, the icons may utilize color and/or shading. In addition, bitmap sources may be applied so that any of the configurations provided for herein may utilize bitmaps. For example, with caricaturing, as a scaling down occurs, certain details may be preserved.

In one embodiment, the icon may be displayed at multiple resolutions, e.g., 0.25×, 0.5×, 1.5×, 2×, etc. The user may then alter the icon at different resolutions. Accordingly, the user may make different adjustments to different size levels. For example, a tweak may only apply at multiples of one third, but not multiples of one quarter. As another example, on displays with ordered color triplets composing pixels, different sets of hints may be applied to the striped and unstriped axes.

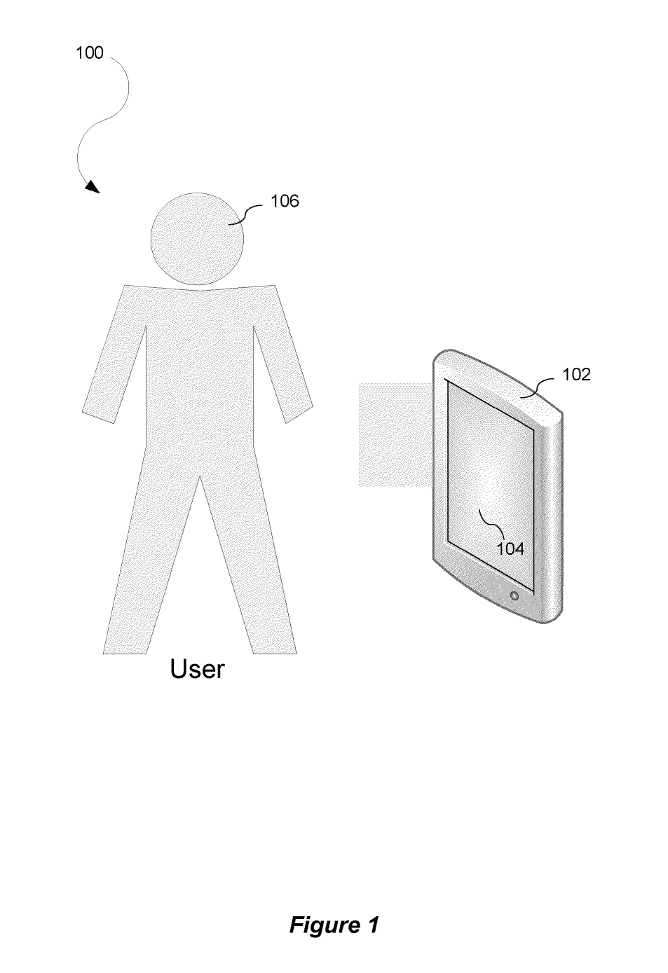

FIG. 1 illustrates a computing environment 100 that may be utilized for shape scaling in a GUI 104. The computing device 102 may be any device with a processor such as a computer tablet, personal computer, laptop, notebook, cell phone, smart phone, personal digital assistant, personal medial player, set top box, etc. The computing device 102 is illustrated as a tablet only for illustrative purposes.

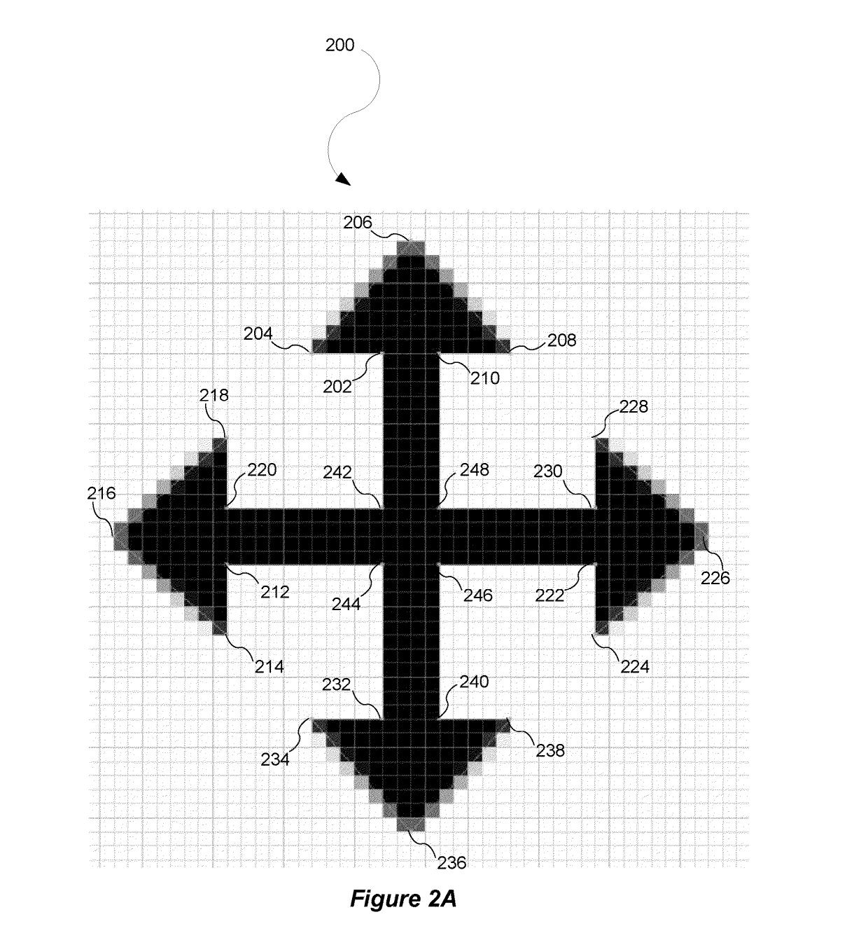

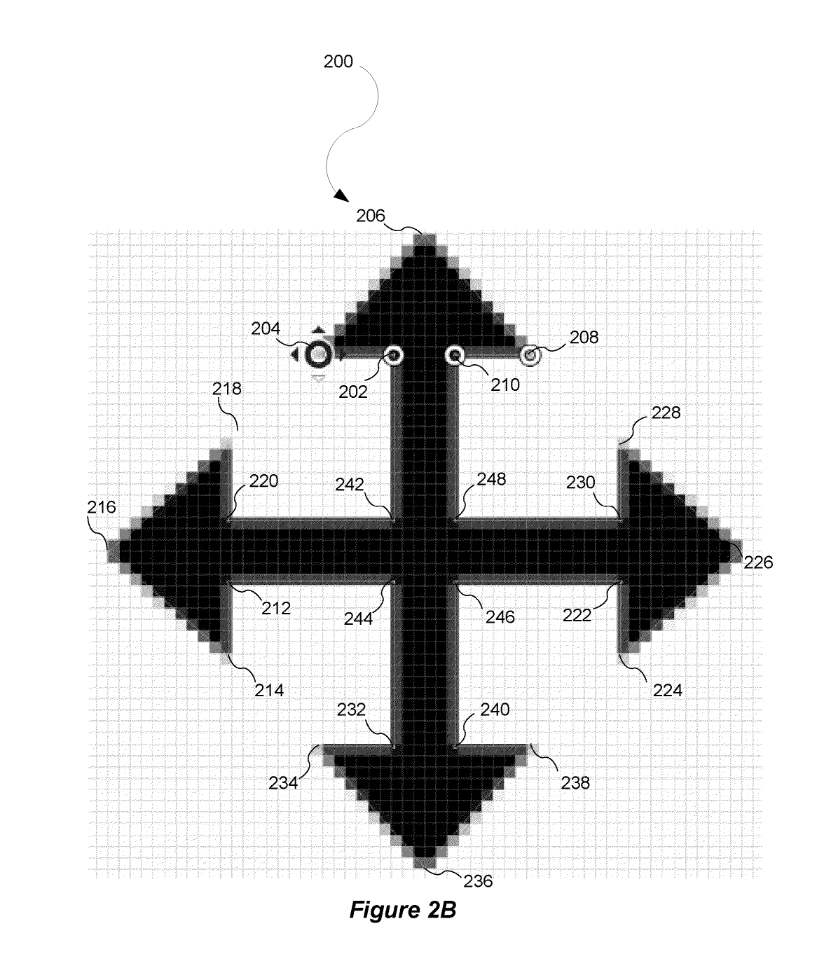

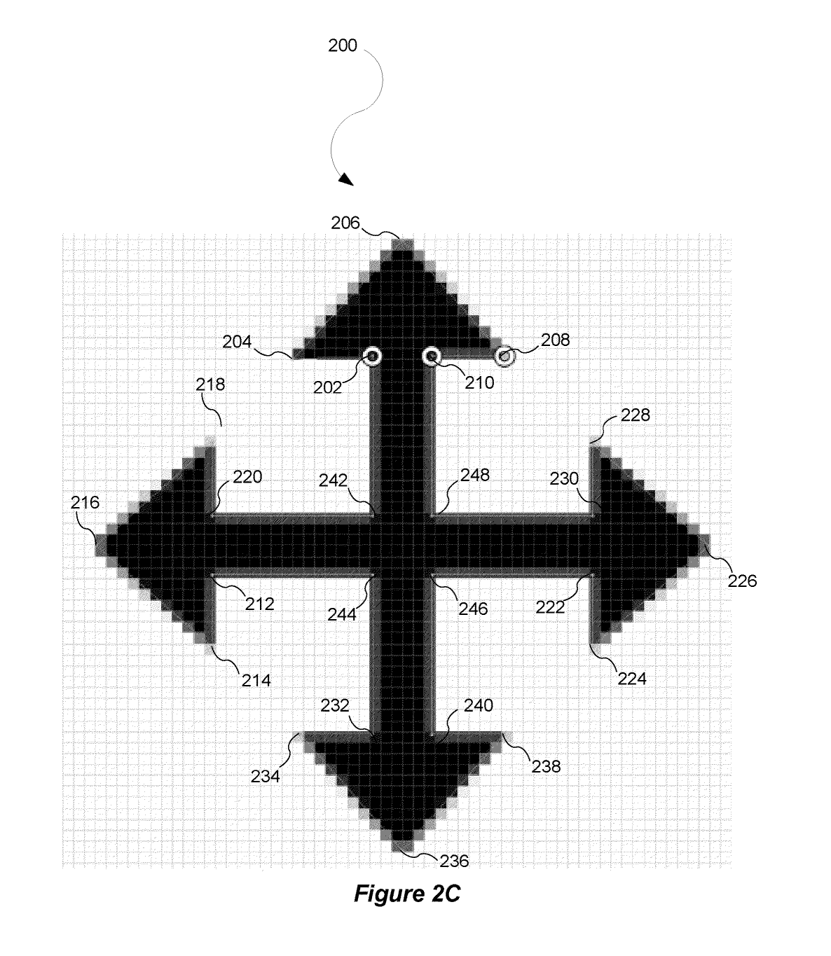

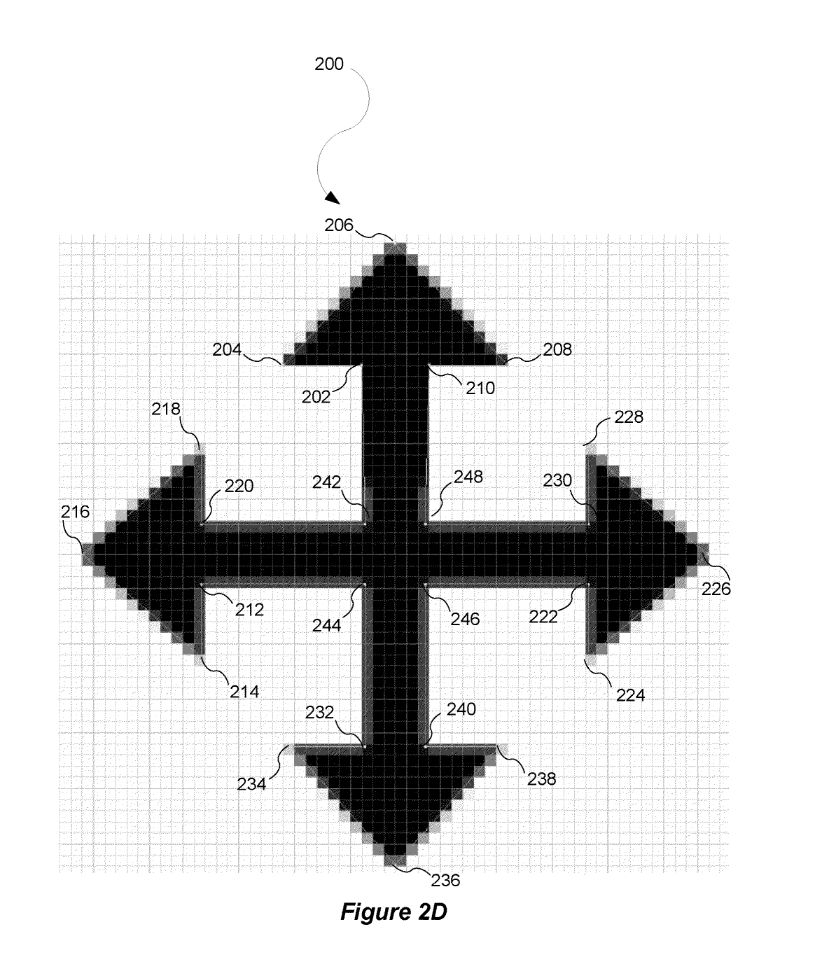

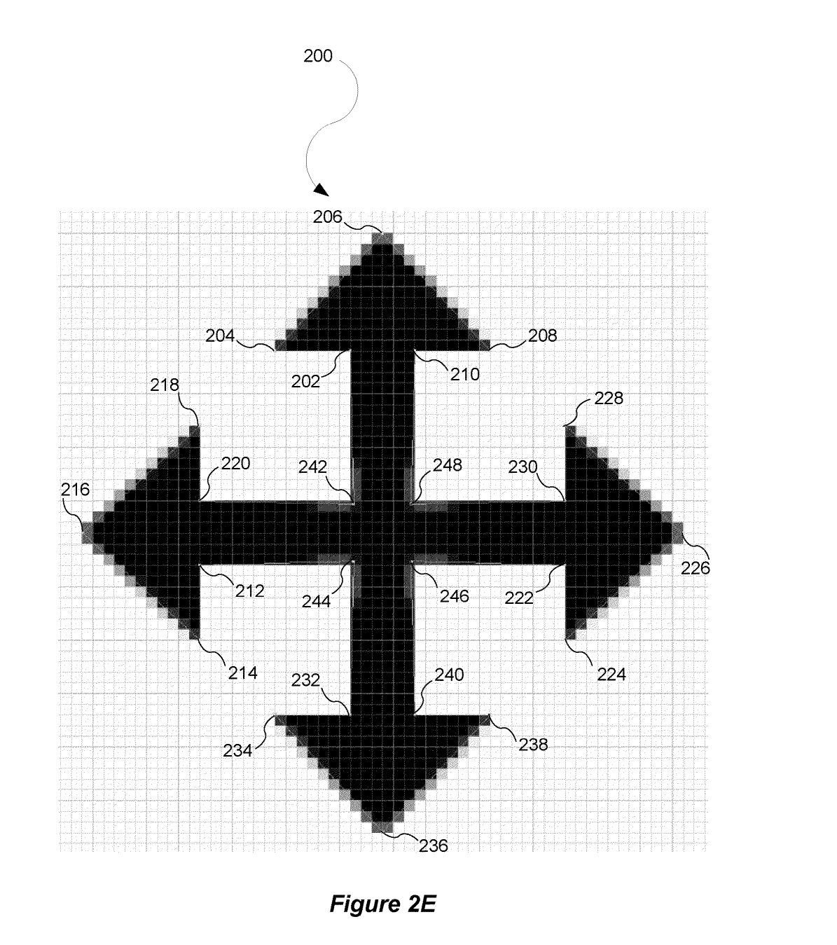

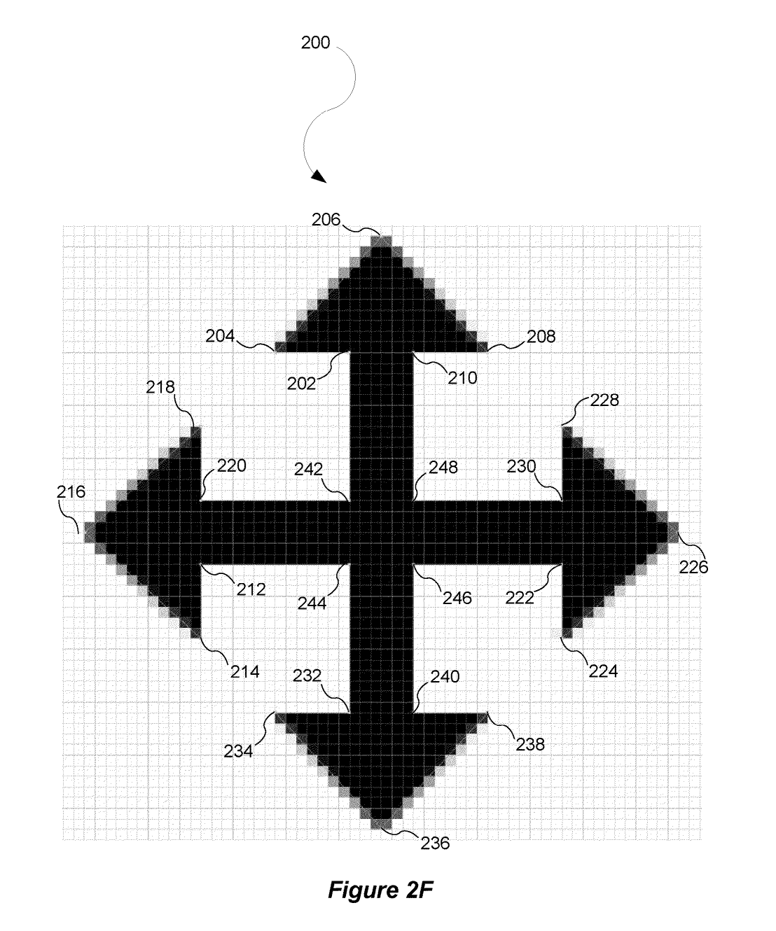

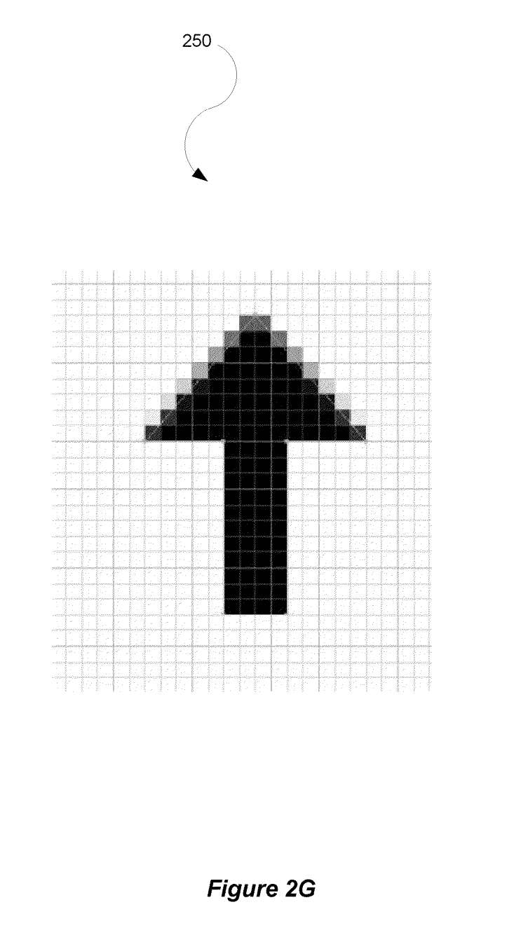

FIG. 2A illustrates an example of an icon 200 that is displayed on a grid. Both vector lines and pixels are displayed for the icon 200. The icon 200 may be constructed from, among other things, an arrow symbol 250 as illustrated in FIG. 2G. The vector lines illustrate an outline of the icon 200. Further, a plurality of vector points along the vector lines is illustrated. For example, the arrow illustrated at the top of the icon 200 has a first vector point 202, a second vector point 204, a third vector point 206, a fourth vector point 208, and a fifth vector point 210. In addition, the arrow illustrated at the left of the icon 200 has a first vector point 212, a second vector point 214, a third vector point 216, a fourth vector point 218, and a fifth vector point 220. The arrow illustrated at the right of the icon 200 has a first vector point 222, a second vector point 224, a third vector point 226, a fourth vector point 228, and a fifth vector point 230. Further, the arrow illustrated at the bottom of the icon has a first vector point 232, a second vector point 234, a third vector point 236, a fourth vector point 238, and a fifth vector point 240. The icon 200 also has a first intersection point 242, a second intersection point 244, a third intersection point 246, and a fourth intersection point 248.

A vector point may be selected so that the vector point may be relocated within the grid to scale the icon according to scaling requirements. FIG. 2B illustrates an example of a selection of a vector point. For example, the second vector point 204 in the top arrow may be selected. An indicia such as a symbol with four arrows may be utilized to indicate the selection. In one embodiment, the vector points that are on a same axis are also highlighted. For instance, the first vector point 202, the fifth vector point 210, and the fourth vector point 208 of the top arrow are also highlighted as they are on the same y-axis as the second vector point 204 of the top arrow.

FIG. 2C illustrates a repositioning of the selected vector point in FIG. 2B. In particular, the selected vector point is repositioned to an integer value point on the pixel grid. The hinting may balance between pixel snapping to have sharp and smooth lines and symmetry such as radial symmetry, mirror symmetry, or symmetry of linear repetition.

Further, FIG. 2D illustrates a repositioning of the additional highlighted points illustrated in FIGS. 2B and 2C. The first vector point 202, the fifth vector point 210, and the fourth vector point 208 of the top arrow are repositioned to the same y-axis coordinate in response to the first vector point 202 being repositioned to the y-axis coordinate. This additional repositioning is optional for the user.

In addition, FIG. 2E illustrates a repositioning of other parts of the icon 200. Since the icon 200 has a plurality of similar arrow heads, the other arrow heads may be repositioned in a similar pattern to that of the top arrow head.

FIG. 2F illustrates the center points of the icon 200 being repositioned. In other words, the first intersection point 242, the second intersection point 244, the third intersection point 246, and the fourth intersection point 248 are repositioned in a similar pattern to that of the arrow heads.

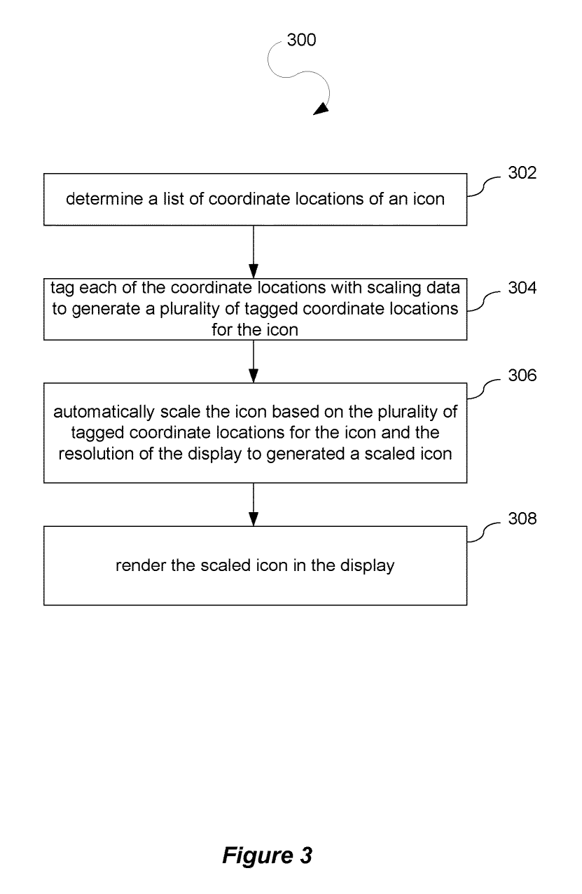

FIG. 3 illustrates a process 300 that provides shape scaling. At a process block 302, the process 300 determines a list of coordinate locations of an icon. As an example, the coordinate locations are x and y coordinates in a grid as seen in FIG. 2. The coordinate locations may have vectors points such as the first vector point 202, the second vector point 204, etc. as seen in FIG. 2. Further, at a process block 304, the process 300 tags each of the coordinate locations with scaling data to generate a plurality of tagged coordinate locations for the icon. The scaling data indicates an automatic scaling adjustment based on a size of the icon being changed to accommodate a resolution of a display. In one embodiment, the scaling data is received from the user when the user manually zooms the displayed interface. In another embodiment, the scaling data may be received from the operation system, which may directly provide the size and resolution of the display. Although many devices utilize square pixels, some devices may utilize pixels that are not necessarily square. Accordingly, the configurations provided for herein work for systems independent of their pixel aspect ratio. Variations of the hinting methodologies may be utilized to optimize the display of icons when displayed in a three-dimensional projected space or mapped onto an uneven surface. In such situations, the pixel grid would not only be different between the horizontal axis and the vertical axis, but may also vary across a single axis. Accordingly, with respect to different axes, an icon may be scaled the same amount or a different amount on each axis. The scaling may also be based on a physical size so that a specific set of dimensions, e.g., one centimeter by one centimeter, is provided. In addition, at a process block 306, the process 300 automatically scales the icon based on the plurality of tagged coordinate locations for the icon and the resolution of the display to generate a scaled icon. At a process block 308, the process 300 also renders the scaled icon in the display. In contrast with the vector graphics approach that does not scale well for small icons below a certain size, the hinting methodologies provided for herein scale down icons to a resolution small enough for computing devices such as smart phones.

In one embodiment, the hinting may be performed by example. For example, the system may monitor what adjustments are applied at different sizes to vector shapes and then guess future adjustments. In other words, the user input may be utilized to make better assessments. The user may review the guesses that the system has made to determine which guesses are correct and which are not. The system may work with or without this learning functionality. In one embodiment, the system may display the output in a number of resolutions. Further, the system may display previews with or without the adjustments.

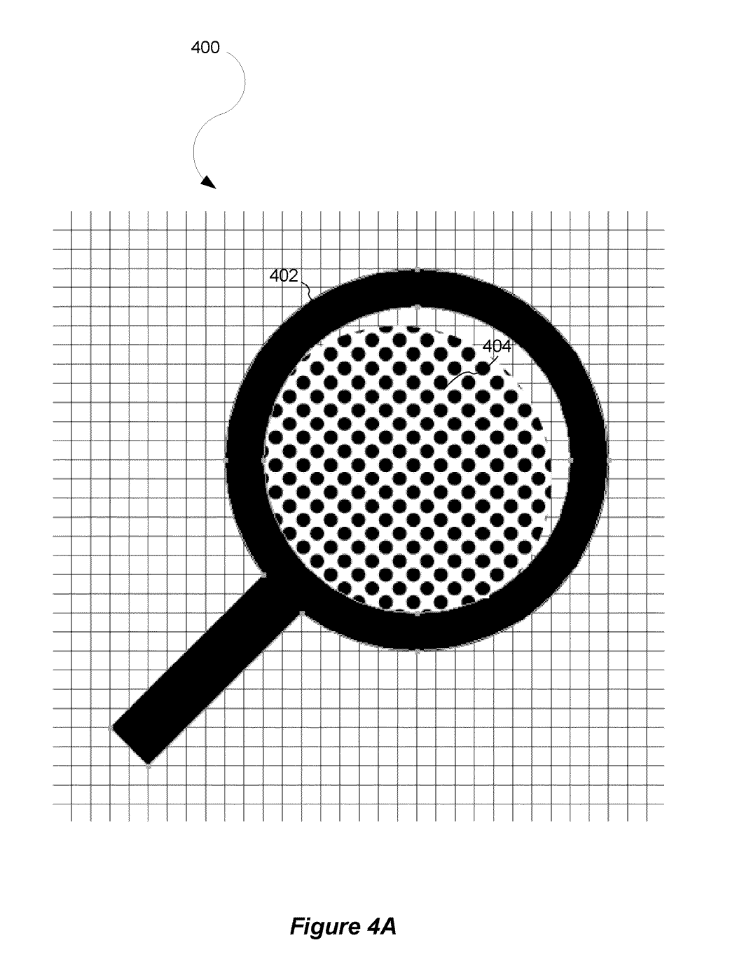

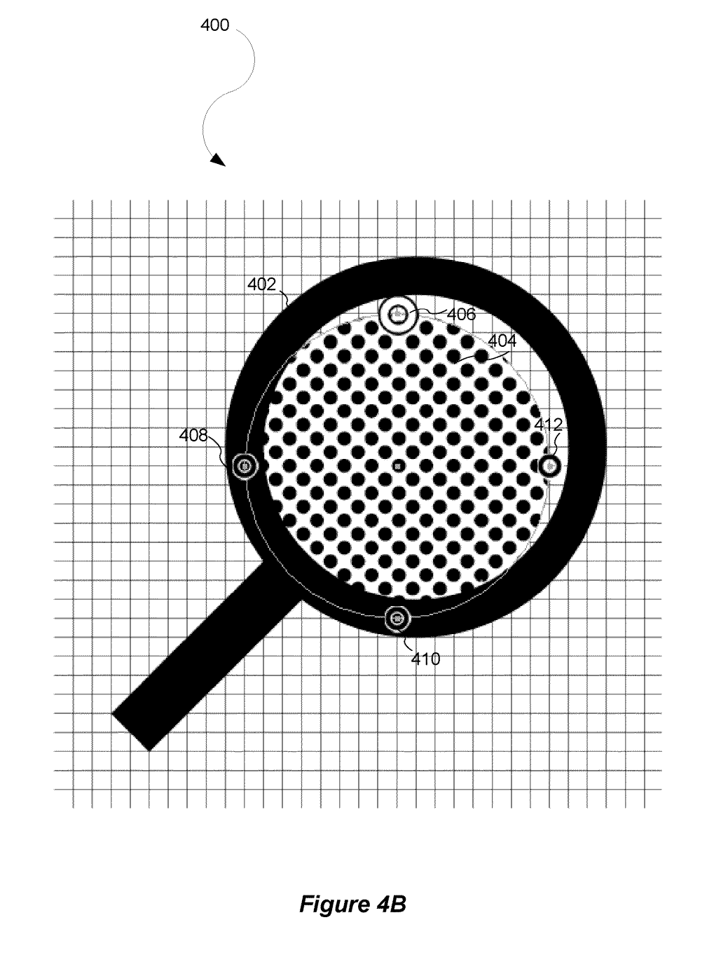

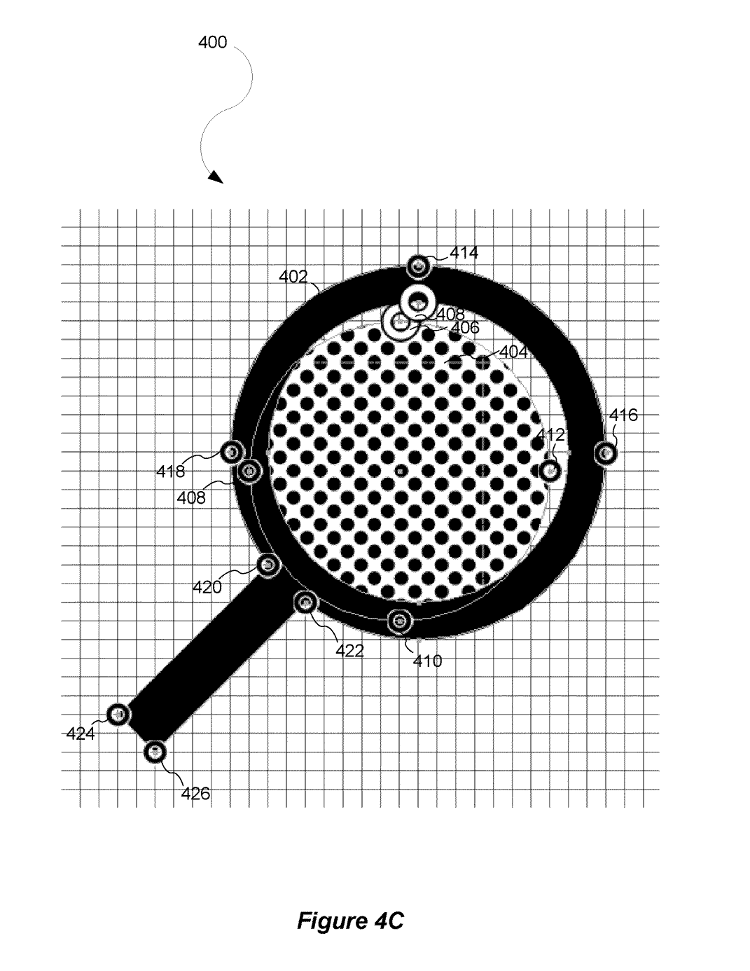

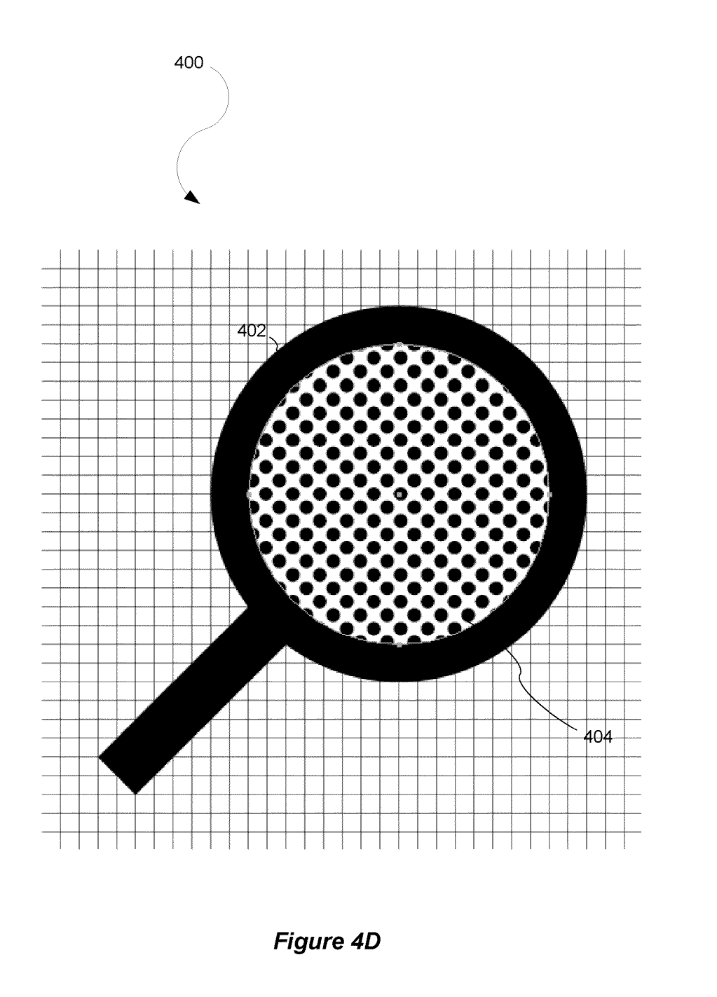

In another embodiment, the hinting may be utilized with color. As an example, a curve may be marked as having to stay together when scaled. FIG. 4A illustrates an example of an image of a magnifying glass 400 having an outline 402 and a lens 404 that have to stay together. The outline may have a color such as black, and the lens may have a color such as blue. The system marks the magnifying glass image accordingly so that if hinting is applied to one piece, e.g., the outline 402 is scaled, then hinting is also applied to the lens 404 so that the lens 404 is scaled also. The outline 402 has been selected and scaled leaving an offset between the outline 402 and the lens 404. FIG. 4B illustrates a selection of the lens 404. A selection of one or more vector points on the lens 404 may be performed. For example, the lens 404 may have a first vector point 406, a second vector point 408, a third vector point 410, and a fourth vector point 412. A selection of one or more of these points may be performed to map to the outline 402. FIG. 4C illustrates a plurality of vector points on the outline 402. As an example, the outline may have a first vector point 414, a second vector point 416, a third vector point 418, a fourth vector point 420, a fifth vector point 422, a sixth vector point 424, and a sixth vector point 426. In one embodiment, each of the individual vector points on the lens 404 may be remapped such that each of the individual vector points on the lens 404 maps to an individual vector point on the outline 402. In another embodiment, a single vector point on the lens 404 may be remapped such that the particular vector point maps to an individual vector point on the outline 402. The remaining vector points on the lens 404 may then be remapped such that they receive the same remapping as the first vector point. FIG. 4D illustrates a resulting magnifying glass image that has a scaled outline 402 and a scaled lens 404 that conform with one another. With respect to multiple colors, specific adjustments may be made for each individual shape with a different color based on the neighboring pixels. As an example, green next to red may have a certain effect. The hinting adjustments may also be made based on different sizes. The pixels may have positive or negative effects. An authoring tool may be utilized to make independent adjustments on different objects, but make one or more changes on one or more of the subparts of an individual object that will result in one or more changes one or more other subparts of the individual object.

The hinting configurations provided for herein may also be utilized for subpixel addressing, i.e., a side effect of color fringes being displayed as colors may be displayed where they should not. As an example, users often turn smartphones sideways to use the smartphones. However, the bitmaps that work well for portrait mode may not work well with landscape mode. In one embodiment, fine hinting adjustments may be made to minimize possible color fringes. The color fringing is carefully tuned so that, when displayed in the correct orientation, the spatial resolution is visibly improved. Scaling may be displayed as a mix of thick and thin slices. A rule may be specified that on output of white colored items should be displayed with the same width, an output of dark colored items should be displayed with the same width, and an output of white colored items and dark colored items should have the same width.

The shapes illustrated above are provided only as examples. The hinting configurations may be applied to outlines, individual symbols, lines, or the like.

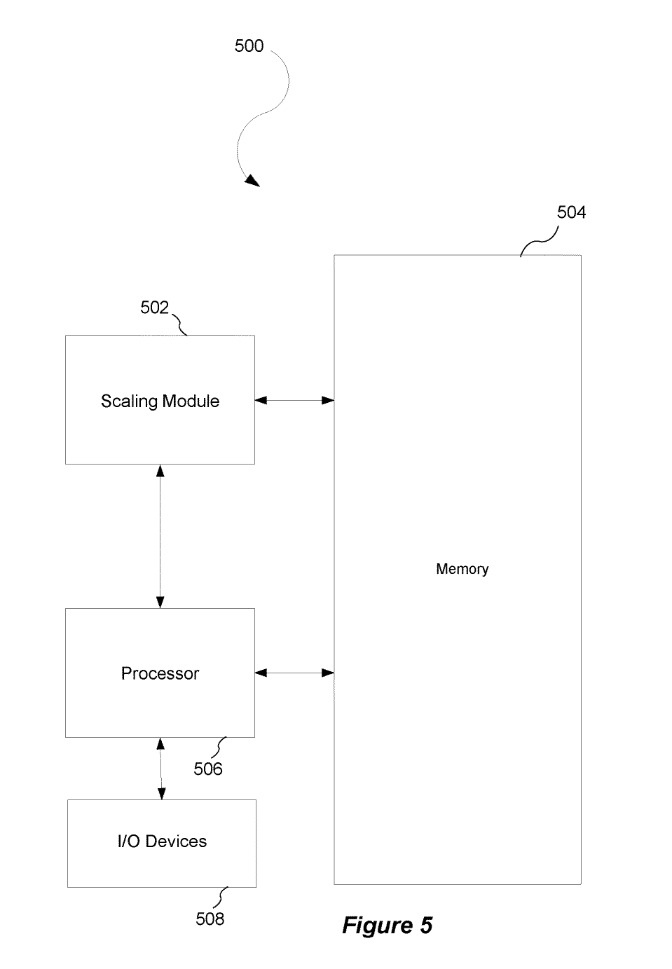

FIG. 5 illustrates a system configuration 502 that may be utilized for navigation. In one embodiment, a scaling module 502 interacts with a memory 504. In one embodiment, the system configuration 502 is suitable for storing and/or executing program code and is implemented using a general purpose computer or any other hardware equivalents. The processor 506 is coupled, either directly or indirectly, to the memory 504 through a system bus. The memory 504 can include local memory employed during actual execution of the program code, bulk storage, and/or cache memories which provide temporary storage of at least some program code in order to reduce the number of times code must be retrieved from bulk storage during execution.

The Input/Output (“I/O”) devices 508 can be coupled directly to the system configuration 502 or through intervening input/output controllers. Further, the I/O devices 508 may include a keyboard, a keypad, a mouse, a microphone for capturing speech commands, a pointing device, and other user input devices that will be recognized by one of ordinary skill in the art. Further, the I/O devices 508 may include output devices such as a printer, display screen, or the like. Further, the I/O devices 508 may include a receiver, transmitter, speaker, display, image capture sensor, biometric sensor, etc. In addition, the I/O devices 508 may include storage devices such as a tape drive, floppy drive, hard disk drive, compact disk (“CD”) drive, etc.

Network adapters may also be coupled to the system configuration 502 to enable the system configuration 502 to become coupled to other systems, remote printers, or storage devices through intervening private or public networks. Modems, cable modems, and Ethernet cards are just a few of the currently available types of network adapters.

The processes described herein may be implemented in a general, multi-purpose or single purpose processor. Such a processor will execute instructions, either at the assembly, compiled or machine-level, to perform the processes. Those instructions can be written by one of ordinary skill in the art following the description of the figures corresponding to the processes and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized data through wireline or wireless transmissions locally or remotely through a network. A computer is herein intended to include any device that has a general, multi-purpose or single purpose processor as described above.

It should be understood that the processes and systems described herein can take the form of entirely hardware embodiments, entirely software embodiments, or embodiments containing both hardware and software elements. If software is utilized to implement the method or system, the software can include but is not limited to firmware, resident software, microcode, etc.

It is understood that the processes and systems described herein may also be applied in other types of processes and systems. Those skilled in the art will appreciate that the various adaptations and modifications of the embodiments of the processes and systems described herein may be configured without departing from the scope and spirit of the present processes, systems, and computer program products. Therefore, it is to be understood that, within the scope of the appended claims, the present processes, systems, and computer program products may be practiced other than as specifically described herein.

We claim:

1. A computer program product comprising a computer useable medium having a computer readable program, wherein the computer readable program when executed on a computer causes the computer to:
determine a list of coordinate locations of an icon;
tag each of the coordinate locations with scaling data to generate a plurality of tagged coordinate locations for the icon, the scaling data indicating an automatic scaling adjustment based on a size of the icon being changed to accommodate a resolution of a display;
automatically scale the icon based on the plurality of tagged coordinate locations for the icon and the resolution of the display to generated a scaled icon; and
render the scaled icon in the display.

2. The computer program product of claim 1, wherein the icon is vector based.

3. The computer program product of claim 1, wherein the icon is bitmap based.

4. The computer program product of claim 1, wherein the automatic scaling adjustment includes a size adjustment.

5. The computer program product of claim 1, wherein the automatic scaling adjustment includes a color adjustment.

6. The computer program product of claim 1, wherein the automatic scaling adjustment includes a shading adjustment.

7. The computer program product of claim 1, wherein the automatic scaling adjustment includes a rule that each edge aligns with a pixel boundary.

8. The computer program product of claim 1, wherein the display is operably connected to a smartphone.

9. The computer program product of claim 1, wherein the display is operably connected to touch enabled device.

10. The computer program product of claim 1, wherein the display is operably connected to a computing device.

11. A method comprising:
determining a list of coordinate locations of an icon;
tagging each of the coordinate locations with scaling data to generate a plurality of tagged coordinate locations for the icon, the scaling data indicating an automatic scaling adjustment based on a size of the icon being changed to accommodate a resolution of a display;
automatically scaling the icon based on the plurality of tagged coordinate locations for the icon and the resolution of the display to generated a scaled icon; and
rendering the scaled icon in the display.

12. The method of claim 11, wherein the icon is vector based.

13. The method of claim 11, wherein the icon is bitmap based.

14. The method of claim 11, wherein the automatic scaling adjustment includes a size adjustment.

15. The method of claim 11, wherein the automatic scaling adjustment includes a color adjustment.

16. The method of claim 11, wherein the automatic scaling adjustment includes a shading adjustment.

17. The method of claim 11, wherein the automatic scaling adjustment includes a rule that each edge aligns with a pixel boundary.

18. A system comprising:
a processor that determines a list of coordinate locations of an icon, tags each of the coordinate locations with scaling data to generate a plurality of tagged coordinate locations for the icon, and automatically scales the icon based on the plurality of tagged coordinate locations for the icon and the resolution of the display to generated a scaled icon, the scaling data indicating an automatic scaling adjustment based on a size of the icon being changed to accommodate a resolution of a display; and
a rendering component that renders the scaled icon in the display.

19. The system of claim 18, wherein the icon is vector based.

20. The system of claim 18, wherein the icon is bitmap based.
